(19) United States
(12) Patent Application Publication
(10) Pub. No.: US 2016/0360141 A1
(43) Pub. Date: Dec. 8, 2016

(54) System and Method for Hybrid Wireless Video Transmission

(71) Applicant: Mitsubishi Electric Research Laboratories, Inc.

(72) Inventors: Toshiaki Koike-Akino, Malden, MA (US); Takuya Fujihashi, Cambridge, MA (US); Philip Orlik, Cambridge, MA (US)

(21) Appl. No.: 14/729,763

(22) Filed: Jun. 3, 2015

(51) Int. Cl. H04N 5/40; H04N 19/625; H04N 19/136; H04N 19/80; H04N 19/44; H04N 19/65; H04N 19/103

(52) U.S. Cl. CPC H04N 5/40; H04N 19/65; H04N 19/625; H04N 19/103; H04N 19/80; H04N 19/44; H04N 19/136

(57) ABSTRACT

A system and method provides high-quality video streaming in wireless video communications. The system includes a digital codec, an analog codec, and a power controller. The output of the digital and analog encoders are superposed and transmitted to a receiver employing a digital and analog decoders over a wireless channel. The method uses high-order modulation for digital encoded data, optimal power allocation for digital and analog data, optimal subcarrier assignment to enhance a water-filling gain, and compressive sensing to reduce packet loss during wireless communications. In addition, the system provides an optimal power allocation for multi-view texture and depth information taken by multiple cameras to improve video quality according to channel quality, camera geometry, and a free-viewpoint rendering procedure based on analysis with polynomial fitting.

### FIELD OF THE INVENTION

This invention relates generally to wireless communications, and more to a system for transmitting and receiving videos over a wireless channel.

### BACKGROUND OF THE INVENTION

With an increase in wireless capability at a physical layer when using orthogonal frequency-division multiplexing (OFDM) and other wireless techniques, video streaming has become a dominant application in wireless communications. In conventional video streaming, the digital video compression and transmission parts operate separately.

The video compression part uses digital video encoder, e.g., MPEG 4 part 10 (H.264/AVC—Advanced Video Coding) and H.265 (HEVC-High-Efficiency Video Coding), to generate a compressed bit stream according to the instantaneous quality of wireless channels. To generate the bit stream, digital video encoder uses quantization, digital entropy coding, spatial and temporal correlation among video frames in a Group of Picture (GoP), which is the sequence of successive video frames.

The transmission part uses channel coding and digital modulation for the bit stream. However, the conventional scheme has two problems because the wireless channel quality is unstable. First, the encoded bit stream is highly vulnerable to bit errors. When the channel signal-to-noise ratio (SNR) falls under a certain threshold and bit errors occur, the video quality decreases rapidly. This phenomenon is called the cliff effect. Second, the video quality remains constant even when the wireless channel quality increases.

To overcome those two problems, various analog transmission schemes have been developed. SoftCast directly transmits a linear-transformed video signal via a lossy analog channel, and allocates power to the signal to maximize video quality, e.g., see Jakubczak et al., “One-size-fits-all wireless video,” ACM HotNets, pp. 1-6, 2009. Instead of requiring the source to pick the bit rate and video resolution before transmission, SoftCast enables the receiver to decode the video with a bit rate and resolution commensurate with the channel quality. In addition, SoftCast uses a Walsh-Hadamard transform (WHT) to redistribute energy of video signals across entire video packets for resilience against packet loss. In contract to the conventional scheme, the video quality of SoftCast is proportional to the wireless channel quality.

Additionally, when some packets are lost during communications, the quality of SoftCast degrades significantly. To keep high video quality even in such an erasure wireless channel, compressive sensing (CS) techniques have been recently introduced to analog transmission schemes. Distributed compressed sensing based multicast scheme (DCS-cast) applies CS for SoftCast to increase the tolerance against packet loss, e.g., see Wang et al., “Wireless multicasting of video signals based on distributed compressed sensing,” Signal Processing: Image Communication, vol. 29, no. 5, pp. 599-606, 2014.

However, in theory, an analog scheme with linear transformation, from source signals to channel signals, is relatively inefficient. The performance of the analog scheme becomes worse as a ratio of maximum variance to minimum variance of source component increases.

To increase the video quality as the wireless channel quality improves, hybrid digital-analog (HDA) transmission schemes have been investigated. HDA schemes provide the benefits of both digital entropy coding and SoftCast. Specifically, a transmitter encodes each video frame using digital video encoder and then determines residuals between the original and encoded video frames. The entropy-coded bit stream is channel-coded and modulated by binary phase-shift keying (BPSK). The residuals are modulated using SoftCast. Then, the two modulated signals are combined and transmitted. As the result, the hybrid schemes achieve higher video quality compared to SoftCast because the ratio of maximum variance to minimum variance decreases.

However, the conventional HDA schemes have two problems. First, most of the existing schemes only use BPSK, which is a low-order modulation scheme having low spectral efficiency. Hence, even when the wireless channel quality is high, the BPSK modulation limits the improvement of video quality. Second, many wireless technologies use multiple wireless channels for transmission, and the channels have the different qualities. For example, OFDM decomposes a wideband channel into a set of narrowband subcarriers. A transmitter sends multiple signals simultaneously over different subcarriers. However, the channel gains across the subcarriers are usually different, sometimes by as much as 20 dB.

Accordingly, there is a need in the art for a method that is suitable for video transmission over wireless channels, and simultaneously improves video quality graceful to multiple channel qualities.

### SUMMARY OF THE INVENTION

The embodiments of the invention provide a system and method for hybrid digital-analog (HDA) transmission and reception of a video via a wireless channel that achieves a higher video quality as the quality of the wireless channel increases even if some video packets are lost during communications.

Video frames are encoded according to a digital video encoder, and residuals are modulated based on SoftCast. To improve video quality, the method of the inventions uses high-order modulation, soft-decision decoding, optimal power allocation, subcarrier assignment, unitary transform, and minimum mean-square error (MMSE) filter.

In some embodiments, the method uses four-level pulse-amplitude modulation (4PAM), instead of BPSK, for digital modulation. Due to its higher spectral efficiency, the use of 4PAM enables a higher-quality bit stream encoding by the digital video encoder for the same transmission bandwidth. The higher quality bit stream, in turn, reduces the error in the reconstructed video (i.e., the residuals), which can generally reduce the ratio of maximum variance to minimum variance in the analog encoder part of the hybrid transmission scheme. Additionally, the 4PAM symbols (modulated digital data) are transmitted on the I (In-phase) component while the analog data (residuals) are transmitted on the Q (quadrature-phase) plane to avoid interference with the digital data. In another embodiment, higher-order modulation such as 8PAM is used when the wireless channel has high signal-to-noise ratio (SNR).

To minimize the mean-square error (MSE), which is related to the video quality, of residuals, the method allocates power to the residuals based on a water-filling procedure, which guarantees the minimum MSE within available transmission power. In addition, the water-filling power allocation determines which data should not be transmitted for analog data compression. No transmission power is allocated to some portions of data having small variance less than a water-filling threshold.

The HDA sorts the residuals and subcarriers based on the power and the channel quality to exploit channel diversity. From the power allocation, each residual is selectively assigned to different subcarriers to increase the benefit of the power allocation.

In yet another embodiment, the residuals are re-sampled by a random unitary transform based on compressive sensing (CS). CS improves the loss resilience of the residuals by redistributing the energy across the entire video data. The method uses a block-wise iterative thresholding algorithm to recover residuals for an erasure wireless channel, where packet loss can occur due to interference and synchronization errors.

Some embodiments of the invention provide the HDA system for multi-view video streaming with and without depth sensing data. The method uses optimal power allocation and subcarrier assignment for 5-dimensional data (horizontal/vertical image, time, view, and texture/depth). For free-viewpoint applications, the method allocates the best possible power along texture, depth, and view. The power allocation is determined by a model of the rendering algorithm for synthesizing free-viewpoint.

### BRIEF DESCRIPTION OF THE DRAWINGS

FIG. 1 is a schematic comparing video transmission performance for prior art modulation schemes and the method according to embodiments of the invention;

FIG. 2 is a block diagram of a hybrid digital-analog (HDA) encoder according to embodiments of the invention;

FIG. 3 is a block diagram of an HDA decoder according to embodiments of the invention;

FIG. 4 is a schematic of subcarrier assignment according to embodiments of the invention;

FIG. 5 is a schematic of packetization according to embodiments of the invention;

FIG. 6 is a block diagram of an HDA encoder for multi-view video streaming with depth information according to embodiments of the invention;

FIG. 7 is a block diagram of an HDA decoder for multi-view video streaming with depth information according to embodiments of the invention; and

FIG. 8 is a schematic of power allocation optimizer for multi-view video streaming with depth information according to embodiments of the invention.

### DETAILED DESCRIPTION OF THE PREFERRED EMBODIMENTS

Overview

The embodiments of the invention provide a system and method for hybrid digital-analog (HDA) transmission and reception of a video over a wireless channel. The system includes an encoder and a decoder (codec). The codec can be implemented in software, a processor, or specialized hardware circuits.

In part, the invention is different from existing hybrid schemes in its use of high-order modulation, power allocation, and subcarrier assignment at the transmitter. In addition, the invention uses log-likelihood ratio (LLR)-based soft-decision decoding in the decoder. In one embodiment, the method also uses a random unitary transform and compressive sensing (CS) to reduce the impact of packet loss for an erasure wireless channel. In yet another embodiment, the method of the invention allocates optimal power according to texture, depth, and view for multi-view plus depth (MVD) video streaming with free-viewpoint rendering.

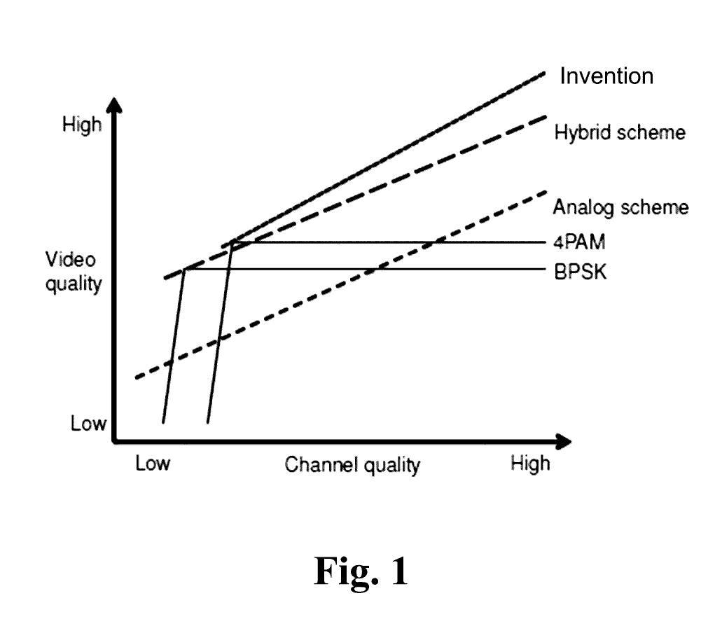

FIG. 1 is a schematic of video quality performance for prior art modulation schemes and that of the method of the invention. The prior art schemes include BPSK, 4PAM, analog, and hybrid analog/digital. When the channel quality becomes low, a cliff effect occurs in the BPSK and 4PAM schemes. Existing analog and hybrid schemes gracefully improve video quality with the improvement of the channel quality. However, the video quality is still low. The method of the invention aims to achieve a higher video quality as the channel quality increases.

Encoder

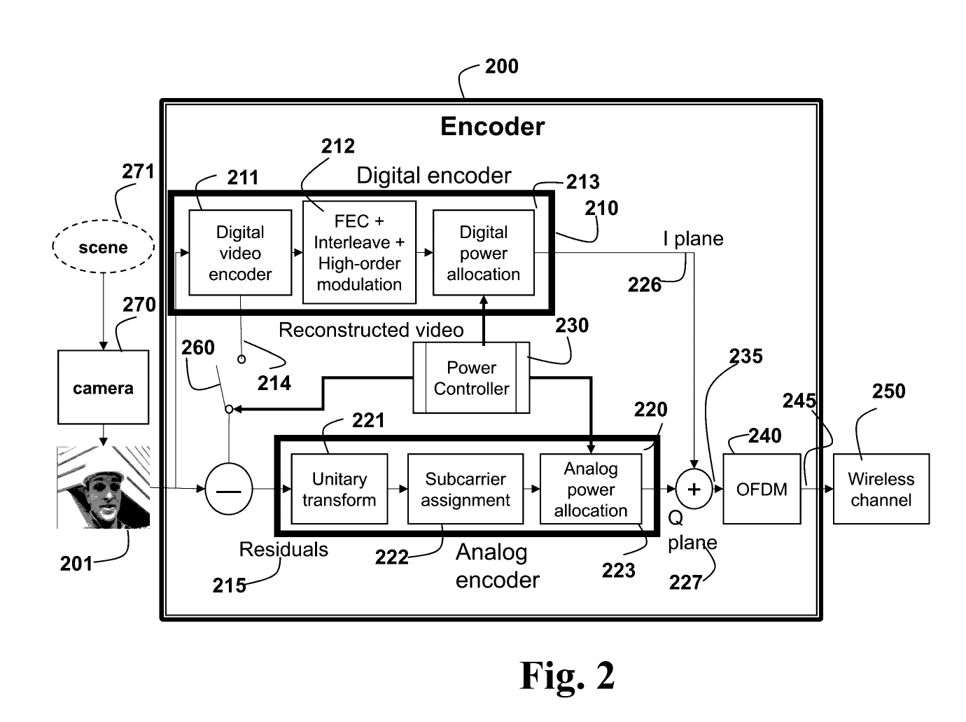

FIG. 2 shows an encoder 200 according to embodiments of the invention. Input to the encoder is video data 201. The encoder includes a digital encoder 210, an analog encoder 220, and a power controller 230. The video data can be acquired by a camera 270, with known geometry, of a scene 271.

The digital encoder 210 includes a digital video encoder 211, a forward error correcting (FEC) encoder, an interleaver, a high-order modulation (e.g., 4PAM) 212, and a digital power allocator 213. The digital video encoder produces a reconstructed video 214. Residuals between original video and the reconstructed digital video 211 are fed to the analog encoder 220 via a switch 260 controlled by a power controller 230. The digital encoder produces an I-plane 226 based on 4PAM or higher-order PAM.

The analog encoder 220 includes a unitary transform module 221, a subcarrier assignment module 222, and an analog power allocator 223. The analog encoder produces a quadrature plane (Q-plane) 227.

The I-plane and Q-plane are combined 235, and OFDM processing 240 is applied to produce a waveform 245 transmitted to a receiver via a wireless channel 250. In one embodiment, single-carrier transmission is used for reducing peak-to-average power ratio.

The power controller 230 determines power levels for the digital and analog power allocators. In addition, the controller operates on/off switch 260 between the digital and analog encoder adaptively.

Decoder

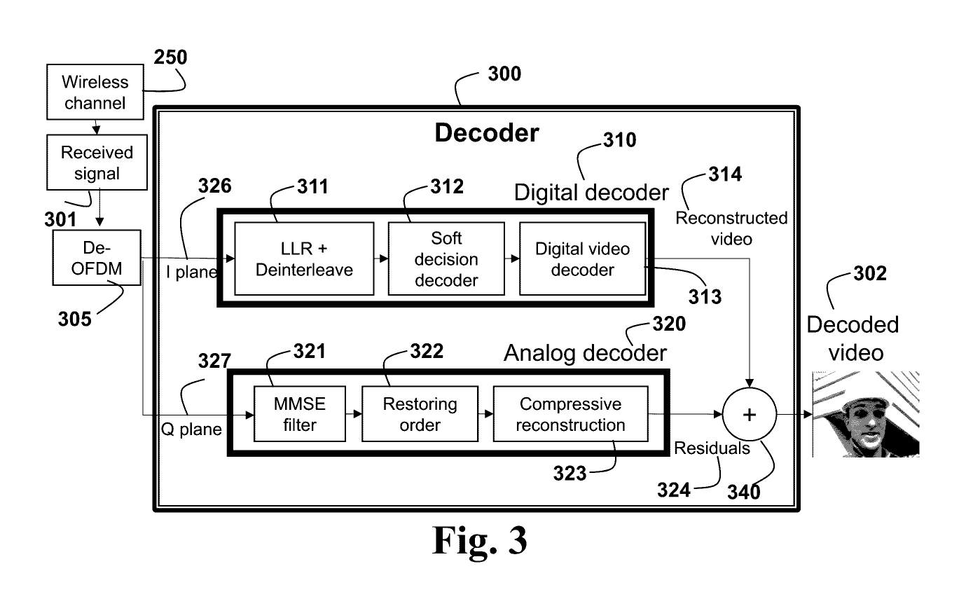

FIG. 3 shows a decoder according to embodiments of the invention. The decoder includes a digital decoder 310 and an analog decoder 320. Input to the decoder is a received signal 301 from a wireless channel 250, with demodulation in a de-OFDM 305 to produce an I-plane signal 326 for the digital decoder, and a Q-plane signal 327 for the analog decoder.

The digital decoder 300 includes an LLR calculator, a deinterleaver 311, a soft-decision decoder 312, and a digital video decoder 313, that produce a reconstructed video 314.

The analog decoder 320 includes a minimum mean-square error (MMSE) filter 321, a restoring order module (which inversely assigns subcarriers) 322, and a compressive reconstruction 323 to produce residuals 324. The reconstructed video and the residuals are combined in an adder to produce a decoded video 302.

Digital Encoder

The digital encoder 210 uses a digital video encoding with interleaved channel code and high-order modulation 212. The encoder operates over the frames in one GoP to generate an entropy-coded bit stream, e.g., based on adaptive quantization and run-length algorithm. The bit stream is coded by a convolutional forward error correcting (FEC) code, and is interleaved to reduce the effect of burst errors due to channel fading. The interleaved stream is modulated using 4PAM, and is mapped to the I-plane. In one embodiment, a capacity-achieving FEC code, such as turbo code and low-density parity-check (LDPC) code, is used. In addition, higher-order PAM such as 8PAM and 16PAM can be used for high SNR regimes.

Analog Encoder

After the digital video encoder generates the bit stream, the analog encoder reconstructs the video frames 214 from the bit stream, and determines residuals 215 between the original and reconstructed video frames. The residuals of all the video frames in one GoP are transformed by a unitary transformer 221, and partitioned into chunks.

For example, in loss-free wireless channels, the encoder uses 2-dimensional discrete cosine transform (2D-DCT), 2-dimensional discrete wavelet transform (2D-DWT), and 3-dimensional DCT (3D-DCT) for the unitary transformer 221. The 2D unitary transform is used for each video frame, and the 3D unitary transform is used for entire video frames.

In another embodiment, for loss-prone wireless channels, the encoder first partitions the residuals into chunks, and uses CS-sampling for each chunk. Each chunk i is converted into a vector vᵢ with a length of B². The vectors are CS-sampled to obtain an observation vector cᵢ as follows:

cᵢ=Φvᵢ, (1)

where the matrix Φ has a size of B²×B². The matrix Φ includes the left-singular vectors of a random matrix, whose elements are random variables generated by a random seed to follow a Gaussian mixture distribution. We use the same matrix Φ for all chunks. The mean and covariance parameters of the Gaussian mixture distribution are pre-determined according to the channel quality and video contents.

After the partitioning, the analog encoder determines the variance of each chunk to determine the power to be allocated to each chunk. The transformed values of each chunk are mapped to the Q-plane after the power allocation and subcarrier assignment.

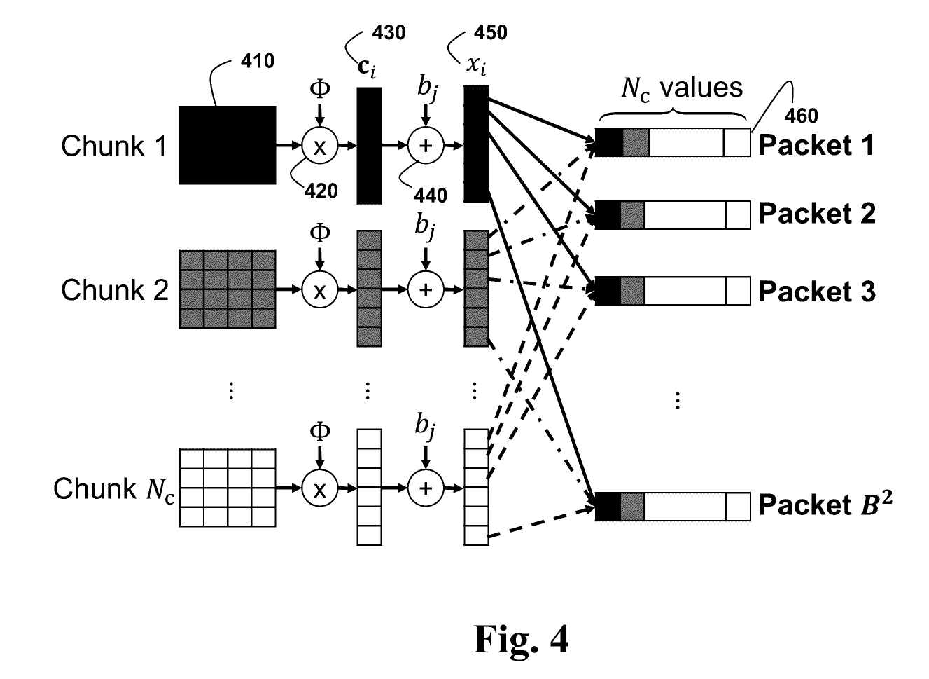

In another embodiment, for the loss-prone wireless channel, the transmitter assigns superposed symbols, which are combined digital modulated symbols and CS-sampled values, to packets as shown and described in greater detail below in FIG. 4. Specifically, elements in chunk i 410 are CS-sampled by the same matrix Φ 420 to produce observation vectors cᵢ 430. Each element in cᵢ is combined with digital modulated symbol bⱼ 440 to produce superposed vectors x_{i,j} 450. The transmitter collects the same element of each superposed vector into one packet 460. After the packetization, the total number of packets is B², and transmission symbols in each packet is N_{c}. In one embodiment, random-interleaved packetization is used.

Power Allocation

In embodiments of the invention, the power controller 230 decides transmission powers for digital and analog encoders based on the wireless channel quality. The controller first decides power allocation for digital encoder to ensure enough power to decode the entropy-coded bit stream correctly. When the channel quality is low, the receiver has difficulty in decoding the bit stream correctly. For that case, the controller switches to analog-only transmission mode to prevent the cliff effect. To decide the transmission power for digital encoder, the power controller calculates the power threshold to decode the bit stream correctly:

$${P}_{th} = \frac{{N}_{sc}}{{Σ}_{i}^{{N}_{sc}} \frac{1}{{σ}_{i}^{2}}} \cdot {γ}_{0} , \qquad ( 2 )$$

where Pₜₕ is the power threshold, N_{sc} is the number of subcarriers in the OFDM channel, and σᵢ² is the noise variance of subcarrier i. Here, γ₀ is the required SNR to guarantee that the decoding bit-error rate (BER) is not larger than a target BER. This target BER depends on the FEC code and wireless channel statistics.

After the threshold calculation, the controller decides the transmission power for digital encoder P_{d} and the transmission power for analog encoder Pₐ, as follows:

$$\begin{matrix}{P}_{d} = \{ \begin{matrix}{P}_{th} , & {P}_{th} \leq {P}_{t} , \\ 0 , & otherwise ,\end{matrix} & ( 3 ) \\ {P}_{a} = {P}_{t} - {P}_{d} , & ( 4 )\end{matrix}$$

where Pₜ is the total power budget per subcarrier. When the power controller decides zero transmission power for digital encoding, the power controller turns off the switch 260 between the digital and analog encoder. After calculating the transmission powers for both encoders, the analog encoder scales the magnitudes of transformed value to provide error resilience to channel noise.

In contrast to SoftCast and prior art hybrid schemes, the method of the invention considers the variance of each chunk and the channel quality of each subcarrier at the same time. In addition, the power controller determines which chunks having small variance are not transmitted to ensure high video quality.

Let x_{i,j} denote a transmission symbol of chunk j on subcarrier i. The symbol x_{i,j} is formed by superposing a 4PAM-modulated symbol [symbol] and analog-modulated symbol [symbol] as follows:

x_{i,j}= [symbol] + [symbol] , (5)

where J=\sqrt{1} denotes the imaginary unit. The 4PAM-modulated symbol and the analog-modulated symbol are scaled by P_{d} and g_{i,j}, respectively as

[symbol]

=\sqrt{P_{d}}·b_{i,j}, (6)

and

[symbol]

=g_{i,j}·S_{i,j}, (7)

where b_{i,j}ε [symbol] ={±1/\sqrt{5}, ±2/\sqrt{5}} is the 4PAM-modulated symbol for subcarrier i, s_{i,j} is the transformed value of chunk j on subcarrier i. Here, g_{i,j} is a scale factor for chunk j on subcarrier i. The received symbol over the OFDM channel in each subcarrier can be modeled as

$${y}_{i , j} = \{ \begin{matrix}{x}_{i , j} + {n}_{i} , & with probability p , \\ e , & with probability 1 - p ,\end{matrix} \qquad ( 8 )$$

where y_{i,j} is the received symbol of chunk j in subcarrier i, nᵢ is an effective noise in subcarrier i, and p is a packet arrival rate. Here, e denotes that the receiver did not receive the transmitted symbol, i.e., the values of I and Q components are unknown. This corresponds to an erasure when the receiver is impaired, e.g., by a strong interference, deep fading, and/or shadowing during wireless communications.

The method of the invention solves the optimization problem of power controls to achieve the highest video quality. Specifically, the method finds the best g_{i,j} to minimize the MSE under the power constraint with total power budget Pₜ, as follows:

$$\begin{matrix}min MSE = {Σ}_{i}^{{N}_{sc}} {Σ}_{j}^{{N}_{c}} \frac{{σ}_{i}^{2} {λ}_{j}}{{g}_{i , j}^{2} {λ}_{j} + {σ}_{i}^{2}} , & ( 9 ) \\ s . t . \frac{1}{{N}_{sc} {N}_{c}} {Σ}_{i}^{{N}_{sc}} {Σ}_{j}^{{N}_{c}} ( {P}_{d} + {g}_{i , j}^{2} {λ}_{j} ) = {P}_{t} , & ( 10 )\end{matrix}$$

where N_{c} is the number of chunks in one GoP and λⱼ is the variance of chunk j. By using the method of Lagrange multipliers, the solution is obtained as

$${g}_{i , j}^{2} = \sqrt{\frac{{σ}_{i}^{2}}{{λ}_{j}}} {( {μ}^{′} - \sqrt{\frac{{σ}_{i}^{2}}{{λ}_{j}}} )}_{+} , \qquad ( 11 )$$

where μ′ is the Lagrangian coefficient, and the operator function (x)₊ is defined as max(x, 0). This solution is analogous to the so-called water-filling power allocation scheme. This equation theoretically proves that the transmitter should not allocate any power to chunks with too small variance (i.e., μⱼ≦σᵢ²/μ′²), and allocate the power to the other chunks.

Subcarrier Assignment

According to equation (11), the power controller allocates one chunk to one subcarrier based on the variance and quality to decrease the MSE. Specifically, the chunks with larger variance are assigned to subcarriers with higher channel quality (i.e., higher SNR). The analog encoder sorts the chunks and subcarriers in descending order before the power allocation, and then assigns the chunk to the corresponding subcarrier.

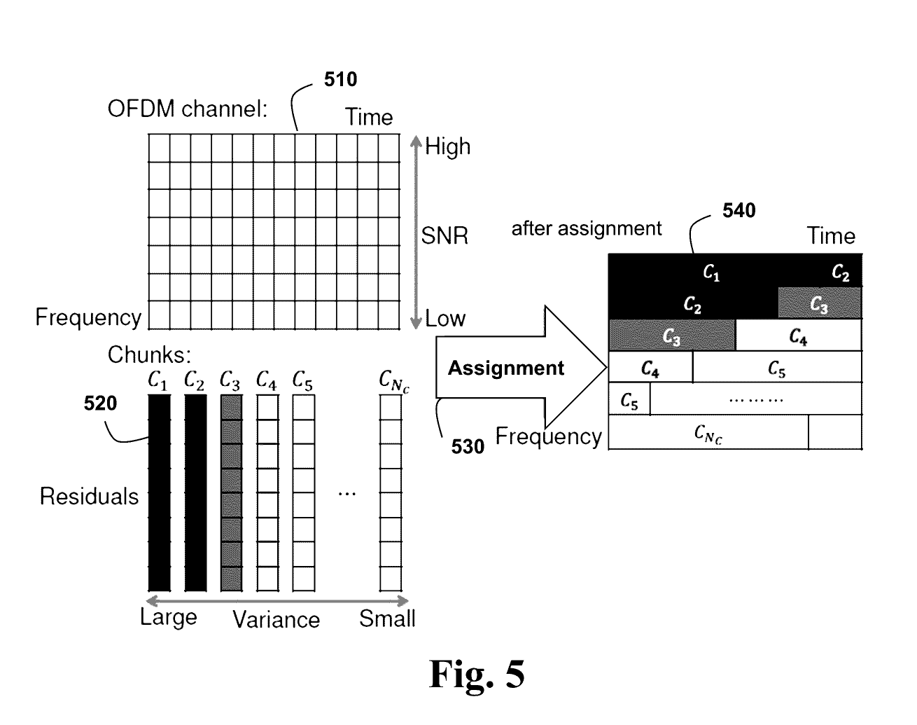

FIG. 5 is a schematic of subcarrier assignment 530. The analog encoder uses a matrix 510, whose column and row are the same as the number of transmission symbols for one GoP and subcarriers, respectively. The rows are sorted in the descending order based on the SNR. The encoder also uses vectors 520 of each chunk Cᵢ and sorts the vectors in descending order based on the variance. Each vector includes h×w elements, which are the unitary-transformed values of the residuals. The encoder assigns 530 the elements in the chunk with the higher variance to the OFDM channel with the higher SNR, sequentially. After decided the assignment, the analog encoder assigns unitary-transformed values of each chunk to OFDM subcarriers based on the matrix as shown in block 540.

Digital Decoder

The receiver first extracts 4PAM-modulated symbol from the I-plane 326 of each subcarrier, i.e., [symbol] (y_{i,j}). To decode the modulated symbol, the digital decoder calculates 311 LLR values from the received symbols. Note that 4PAM consists of 2 bits and the decoder calculates LLR values for both bits as follows:

$$\begin{matrix}{L}_{LSB} = ( \begin{matrix}0 & ℜ ( {γ}_{i , j} ) = e , \\ ln \frac{P ( {y}_{i , j} \vert 01 ) + P ( {y}_{i , j} \vert 11 )}{P ( {y}_{i , j} \vert 00 ) + P ( {y}_{i , j} \vert 10 )} , & otherwise .\end{matrix} & ( 12 ) \\ {L}_{MSB} = ( \begin{matrix}0 & ℜ ( {γ}_{i , j} ) = e , \\ ln \frac{P ( {y}_{i , j} \vert 10 ) + P ( {y}_{i , j} \vert 11 )}{P ( {y}_{i , j} \vert 00 ) + P ( {y}_{i , j} \vert 01 )} , & otherwise .\end{matrix} & ( 13 )\end{matrix}$$

where L_{LSB} and L_{MSB} are the LLR values of least significant bit (LSB) and most significant bit (MSB), respectively. In addition, P(y_{i,j}|ω) denotes the probability that the received signal is y_{i,j} when the transmitted bits is ω, i.e.,

$$P ( {y}_{i , j} \vert ω ) = \frac{1}{{πσ}_{i}^{2}} exp ( - \frac{1}{{σ}_{i}^{2}} {( ℜ ( {y}_{i , j} ) - M ( ω ) )}^{2} ) , where$$

$$M ( ω ) ∈ \sqrt{{P}_{d}} \cdot 𝕏$$

is the 4-PAM modulated symbol for ω. The LLR calculation is done for any higher-order modulation in a similar manner.

After computing the LLR values for all received symbols, the receiver deinterleaves the LLR values, and feeds them into the Viterbi decoder. The Viterbi decoder provides the entropy-coded bit stream at its output, and the digital decoder uses the digital video decoder to reconstruct video frames from the bit stream. In one embodiment, the soft-decision decoder uses a belief propagation procedure.

Analog Decoder

The receiver extracts transformed values from the Q-plane 327 of each subcarrier, i.e., [symbol] (y_{i,j}), and uses the MMSE filter 321 for the extracted value except [symbol] (y_{i,j})=e as follows:

$${\hat{s}}_{i , j} = \frac{{g}_{i , j} {λ}_{j}^{2}}{{g}_{i , j}^{2} {λ}_{j}^{2} + {σ}_{i}^{2}} \cdot ( {y}_{i , j} ) . \qquad ( 14 )$$

The decoder then reconstructs chunks according to the subcarrier assignment and obtains the analog residual values by taking the compressive reconstruction 323. In the loss-free wireless channel, the compressive reconstruction 323 uses the inverse unitary transform of the encoder. In the erasure wireless channel, the compressive reconstruction 323 reconstructs the residuals from the limited number of transformed values using a reconstruction algorithm of CS. More specifically, the receiver first generates the B²×B² matrix Φ using the same random seed at the transmitter. The receiver vectorizes the received CS-sampled values of chunk i into a column vector sᵢ. Note that some rows in each column vector may be missed due to packet losses. In this case, the decoder trims the corresponding rows of the matrix Φ. After the trimming, we solve l₁ minimization problem using block-wise compressed sensing (BCS-SPL), e.g., see S. Mun et al., “Block compressed sensing of images using directional transforms,” IEEE International Conference on Image Processing, pp. 3021-3024, 2009.

Specifically, the decoder initializes with vᵢ⁽⁰⁾=Φ^{T}sᵢ and) \hat{v}⁽⁰⁾=Wiener[v⁽⁰⁾], where Wiener[·] is a pixel-wise adaptive Wiener filter for smoothed reconstruction. \hat{v}⁽⁰⁾ is updated using block-wise successive projection and thresholding operation as follows:

$$\begin{matrix}{\hat{\hat{v}}}_{i}^{( l )} = {\hat{v}}_{i}^{( l )} + {Φ}^{T} ( {s}_{i} - Φ {\hat{v}}_{i}^{( l )} ) , & ( 15 ) \\ {\breve{v}}^{( l )} = ( \begin{matrix}{\hat{\hat{v}}}^{( l )} , & \vert Ψ {\hat{\hat{v}}}^{( l )} \vert \geq {τ}^{( l )} , \\ 0 , & otherwise ,\end{matrix} & ( 16 ) \\ {v}_{i}^{( l + 1 )} = {\breve{v}}_{i}^{( l )} + {Φ}^{T} ( {s}_{i} - Φ {\breve{v}}_{i}^{( l )} ) , & ( 17 )\end{matrix}$$

where Ψ is used to transform the output of the (l)th iteration \hat{\hat{v}}^{(l)} onto a sparse domain. For example, the decoder uses 2D-DCT, 2D-DWT, 2-dimensional dual-tree DWT (2D-DDWT), 3D-DCT for Ψ. Here, vᵢ^{(l)} is the vector representing chunk i of entire frames v^{(l)} at the (l)th iteration, and τ^{(l)} is a threshold at the (l)th iteration. This reconstruction terminates when

$$\vert {D}^{( l + 1 )} - {D}^{( l )} \vert < {10}^{- 4} where {D}^{( l )} = \frac{1}{\sqrt{{N}_{c}}} {‖ {v}_{i}^{( l )} - {\hat{\hat{v}}}_{i}^{( l - 1 )} ‖}_{2} .$$

When the reconstruction terminates at an iteration l_{end}, the reconstructed residuals are obtained from v^{(l}^{_{end}}⁺¹⁾. The decoder finally adds the residuals 324 to the reconstructed digital video frames 314 and outputs the decoded video frames 302.

Multi-View Plus Depth (MVD) Video Streaming

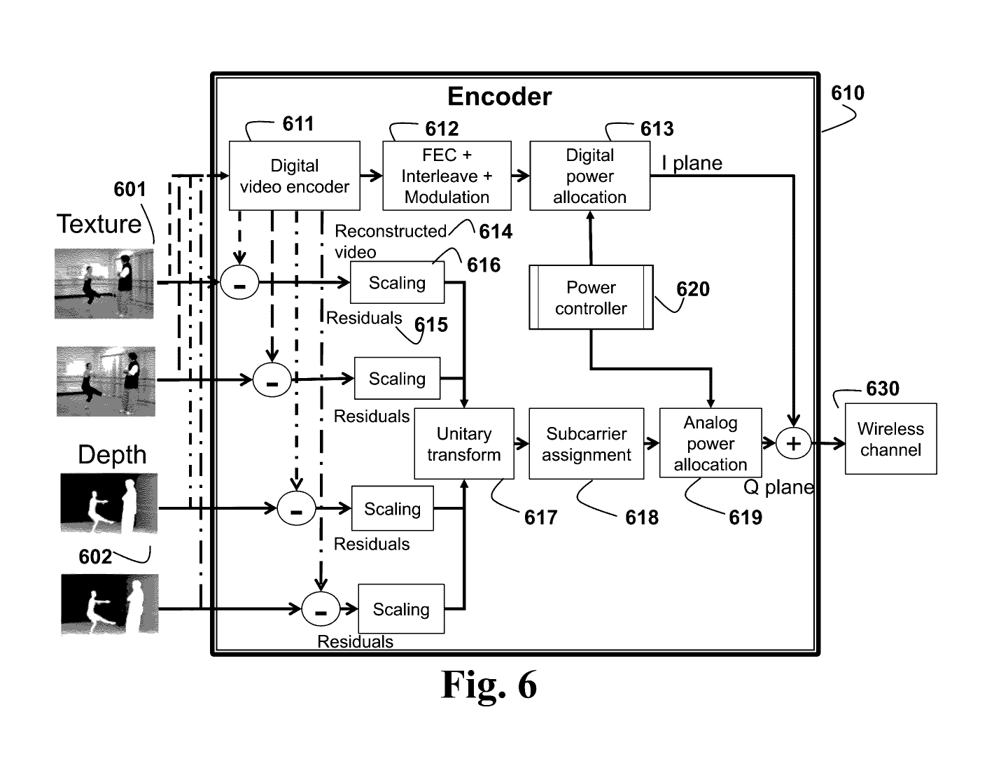

In some embodiments of the invention, the HDA system is used for MVD video streaming. FIG. 6 shows an encoder 610 according to embodiments of the invention. Input to the encoder is texture 601 and depth 602 data of multiple cameras. The encoder includes a digital encoder, an analog encoder, and a power controller 620.

The digital encoder includes a digital video encoder 611, an FEC encoder, an interleaver, a modulation (e.g., BPSK, 4PAM) 612, and a digital power allocator 613. The digital video encoder produces reconstructed texture and depth for each camera 614. Residuals between original video and the reconstructed digital video 615 are fed to the analog encoder. The digital encoder produces an I-plane based on BPSK, 4PAM, or higher-order PAM.

The analog encoder includes scaling modules 616, a unitary transform module 617, a subcarrier assignment module 618, and an analog power allocator 619. The analog encoder produces a Q-plane.

The I-plane and Q-plane are combined to produce a bitstream transmitted to a receiver via a wireless channel 630. The power controller 620 determines power levels for the digital and analog power allocators.

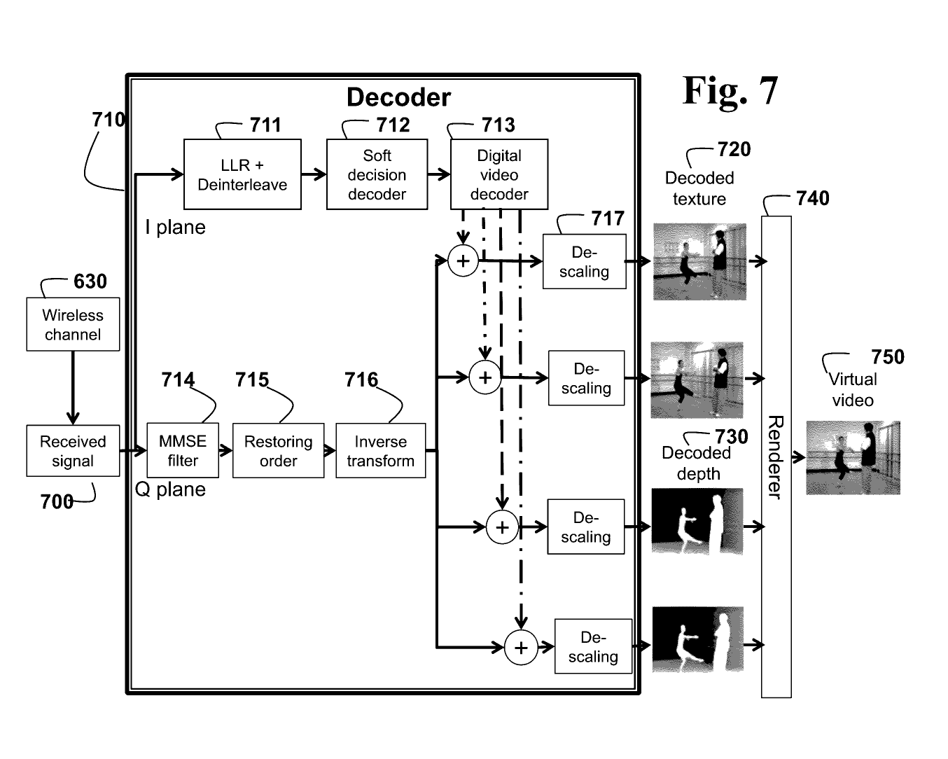

FIG. 7 shows a decoder 710 according to embodiments of the invention. The decoder includes a digital decoder and an analog decoder. Input to the decoder is a received signal 700 from a wireless channel 630, which is demodulated to produce an I-plane for the digital decoder, and a Q-plane for the analog decoder.

The digital decoder includes an LLR calculator, a deinterleaver 711, a soft-decision decoder 712, and a digital video decoder 713, that produce a reconstructed video.

The analog decoder includes an MMSE filter 714, a restoring order module (which inversely assigns subcarriers) 715, and an inverse transform module 716. The reconstructed video and the residuals are combined and de-scaled 717 to produce decoded texture 720 and depth video 730. The decoded texture and depth video are obtained to a renderer 740 to produce virtual video 750 at a free viewpoint.

Multi-View Digital Encoder

The digital encoder 610 uses a digital video encoding with interleaved channel code and modulation 612. The operation is based on single-view HDA encoder. In one embodiment, multi-view based digital video encoder such as H.264/AVC multi-view video coding (MVC), multi-view video coding plus depth (MVC+D), and AVC-compatible extension plus depth (3D-AVC), multi-view extension of HEVC (MV-HEVC), or advanced multi-view and 3D extension of HEVC (3D-HEVC) is used.

Multi-View Analog Encoder

After the digital video encoder generates the bit stream, the analog encoder reconstructs the video frames of texture and depth 614 from the bit stream, and determines residuals of texture and depth 615 between the original and reconstructed video frames. The residuals of texture and depth video frames in each camera are scaled 616 by the same or different values, which are determined by the power controller 620. All the video frames in one GoP are then transformed by a unitary transformer 617 and partitioned into chunks.

For example, the encoder uses 2D-DCT, 2D-DWT, 3D-DCT, 4-dimensional DCT (4D-DCT), and 5-dimensional DCT (5D-DCT) for the unitary transform. The 2D unitary transform is used for each video frame, the 3D unitary transform is used for entire video frames in each camera, the 4D unitary transform is used for entire video frames of all cameras, and the 5D unitary transform is used for entire texture and depth video frames.

After the partitioning, the analog encoder determines the variance of each chunk to determine the power to be allocated to each chunk. The transformed values of each chunk are mapped to the Q-plane after the power allocation and subcarrier assignment.

Scaling

In contrast to single-view video, the transmitter has at least four video sequences, which are left and right viewpoints of texture and depth. When the receiver generates virtual viewpoint video sequences, the video quality varies according to several factors: channel quality, position of virtual viewpoint, scaling factor for texture and depth, scaling factor for left and right viewpoints, and entropy of original video sequences. The method of the invention controls scaling factors to achieve higher video quality depending on other factors noted above.

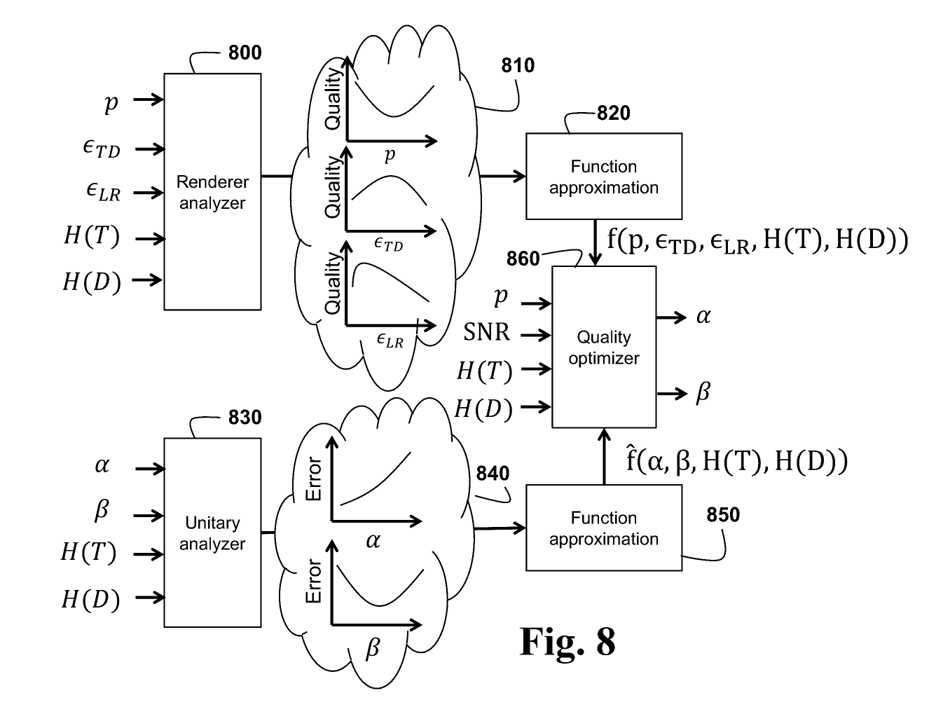

To find optimal scaling factors, the method of the invention uses a unitary analyzer 830, a renderer analyzer 800, and a quality optimizer 830 as shown in FIG. 8. The input to the renderer analyzer 800 is the position of virtual viewpoint p, error ratio for texture and depth video ε_{TD}, error ratio for left and right views ε_{LR}, entropy of texture H(T) and depth H(D) video frames. The renderer analyzer 800 generates virtual viewpoints with different inputs and calculates video quality for each parameter 810. The renderer analyzer finds a function of video quality f(p, ε_{TD}, ε_{LR}, H(T), H(D)) from the results using polynomial fitting 820.

The input to the unitary analyzer 830 is scaling factor for texture and depth α, scaling factor for left and right viewpoints β, entropy of texture H(T) and depth H(D) video frames. The analyzer outputs the magnitude of errors in the video sequences with different scale factors 840. The unitary analyzer finds a function of errors \hat{f}(α, β, H(T), H(D)) from the results using polynomial fitting 850. The input to the quality optimizer 860 is two fitted functions, position of virtual viewpoint, channel quality, and entropy of texture and depth video. The quality optimizer first initializes α and β, and finds the best scaling factors, which achieve the highest video quality at a certain virtual viewpoint, using two fitted functions according to the channel quality. In another embodiments, for example, without depth sensing data, the quality optimizer finds the best scaling factor 13. In yet another embodiment, the scaling factors are optimized such that the worst viewpoint among possible locations is maintained to be high quality.

Free-View Renderer

After the receiver decodes video frames of texture with and without depth, the receiver generates virtual viewpoint from the decoded video frames using image-based rendering operation. For example, if depth data is available, then the receiver uses depth image-based rendering or 3D-warping. Otherwise, the receiver uses view interpolation or view morphing.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A system for transmitting a video over a wireless channel, comprising:
a digital encoder, further comprising:
a digital video encoder;
a forward error correcting (FEC) encoder;
an interleaver;
a high-order modulator; and
a digital power allocator;
an analog encoder, further comprising:
a unitary transformer;
a subcarrier assignment module; and
an analog power allocator; and
a power controller connected to the digital power allocator, the analog power allocator and an on/off switch between the digital video encoder and the unitary transformer.

2. The system of claim 1, wherein the analog encoder transforms residuals by unitary transforms to represent features of the residuals.

3. The system of claim 2, wherein the unitary transform comprises two-dimensional (2D)—discrete cosine transform (DCT), 2D-discrtete wavelet transform (DWT), three-dimensional (3D)—DCT, 4D-DCT, 5D-DCT, or compressive sampling (CS)—sampling based on left-singular vectors of random matrix, which follows a Gaussian mixture distribution.

4. The system of claim 1, wherein input to the encoder is video data, wherein the analog encoder selectively assigns unitary-transformed values to subcarriers to utilize a channel diversity, wherein the video data having smaller variances are assigned to subcarrier having lower signal-to-noise ratio.

5. The system of claim 1, wherein the analog power allocator adaptively scales transformed values based on the variance of the transformed values and a channel quality.

6. The system of claim 1, wherein the digital encoder produces an in-phase plane (I-plane), and the analog encoder produces a quadrature plane (Q-plane) to avoid interference.

7. The system of claim 6, wherein the I-plane and the Q-plane are combined, and modulated using orthogonal frequency-division multiplexing (OFDM) to transmit a bitstream over wireless channels, wherein a number of subcarriers is greater than 1 or equal to 1.

8. The system of claim 7, wherein the power controller operates the on/off switch to switch between the digital encoder and the analog encoder adaptively according to a quality of the wireless channels.

9. The system of claim 1, further comprising:
a digital decoder, further comprising:
a log-likelihood ratio (LLR) calculator;
a soft-decision FEC decoder; and
a digital video decoder;
an analog decoder, further comprising:
a minimum mean-square error (MMSE) filter;
a restoring order module; and
a compressive reconstruction; and
a data combiner, further comprising:
an adder; and
a free-viewpoint renderer.

10. The system of claim 9, wherein input to the digital decoder is an in-phase plane (I-plane) of a received signal, and input to the analog decoder is a quadrature plane (Q-plane) of the received signal.

11. The system of claim 10, wherein the I-plane and the Q-plane are produced by demodulating the received signal.

12. The system of claim 9, wherein input to the encoder is video data, and wherein the analog decoder estimates residuals in the video data from received signals using a variance of the residuals and a channel quality.

13. The system of claim 9, where input for the compressive reconstruction are taken by an inverse transform operation of the encoder, wherein the inverse transform operation includes a two-dimensional (2D)—inverse discrete cosine transform (IDCT), a 2D-inverse discrete wavelet transform (IDWT), a three-dimensional (3D)—IDCT, 4D-IDCT, 5D-IDCT, or a compressive sensing (CS) reconstruction with an adaptive Wiener filter, to reconstruct the residuals.

14. The system of claim 1, wherein residuals of the digital encoding are partitioned into chunks, and wherein power allocation and subcarrier assignment are performed for each chunk.

15. The system of claim 1, wherein the digital video encoder uses multi-view video data taken by multiple cameras, and encodes depth data at the same time.

16. The system of claim 1, the power controller adaptively allocates power levels for digital multi-view video data, analog multi-view residuals, digital depth data, and analog depth data according to a polynomial fitting model based on camera geometry, signal-to-noise ratio, entropy of the video, and the free-viewpoint rendering algorithm.
